(19) United States
(12) Patent Application Publication
(10) Pub. No.: US 2009/0014964 A1
(43) Pub. Date: Jan. 15, 2009

(54) Angled honeycomb seal between turbine rotors and turbine stators in a turbine engine

(75) Inventors: Zhengxiang Pu, Orlando, FL (US); Yan Yin, Orlando, FL (US)

Correspondence Address: Siemens Corporation;Intellectual Property Department, 170 Wood Avenue South, Iselin, NJ, 08830, US

(73) Assignee: Siemens Power Generation, Inc.

(21) Appl. No.: 11/825,692

(22) Filed: Jul. 9, 2007

(51) Int. Cl. F01D 11/08; F04D 29/08; F16J 15/447

(52) U.S. Cl. 277/414; 415/173.5

(57) ABSTRACT

A seal system for an intersection between a turbine stator and a turbine rotor to seal cooling fluids. The seal system may be formed from a seal base extending from the turbine stator, an arm extending radially outward from the turbine rotor and toward the seal base but terminating short of the seal base thereby creating a gap between the seal base and the arm. The seal system may include a honeycomb shaped seal attached to the seal base and extending radially inward from the seal base toward the arm. An outer sealing surface of the seal may be nonparallel with a longitudinal axis about which the turbine rotor rotates thereby enabling the distance of the gap to be reduced with axial movement of the turbine rotor.

### FIELD OF THE INVENTION

This invention is directed generally to turbine engines, and more particularly to seal systems for the intersection between turbine stators and rotors to seal cooling systems.

### BACKGROUND

Typically, gas turbine engines include a compressor for compressing air, a combustor for mixing the compressed air with fuel and igniting the mixture, and a turbine blade assembly for producing power. Combustors often operate at high temperatures that may exceed 2,500 degrees Fahrenheit. Typical turbine combustor configurations expose turbine vane and blade assemblies to these high temperatures. As a result, turbine vanes and blades must be made of materials capable of withstanding such high temperatures. In addition, turbine vanes and blades often contain cooling systems for prolonging the life of the vanes and blades and reducing the likelihood of failure as a result of excessive temperatures. Turbine engines typically include a plurality of rows of stationary turbine vanes extending radially inward from a shell forming a stator and include plurality of rows of rotatable turbine blades attached to a rotor assembly that rotates relative to the turbine stator. Typically, a turbine rim seal seals the gaps between the turbine stators and turbine rotors to prevent mixing of cooling fluids and the hot gases in the hot gas pathway. Many different configurations of seals have been developed to seal this interface, however, leakage persists. Thus, a need exists for a seal capable of effectively sealing the gap between turbine rotors and turbine stators.

### SUMMARY OF THE INVENTION

This invention relates to a seal system for an intersection between two turbine components in a gas turbine engine. In at least one embodiment, the seal system may be configured to seal a gap at a gas turbine rim seal between a turbine stator and a turbine rotor. The seal system may be configured such that as the turbine engine heats up while moving through transient engine operation and approaching a steady state operating condition and the turbine rotor undergoes axial movement, the distance across the gap between the turbine stator and the turbine rotor is reduced.

The seal system may include a seal base extending from the turbine stator and an arm extending from the turbine rotor and toward the seal base but terminating short of the seal base thereby creating a gap between the seal base and the arm. The seal system may also include a seal attached to the seal base and extending radially inward from the seal base toward the arm. The outer sealing surface of the seal may be nonparallel with a longitudinal axis about which the turbine rotor rotates thereby enabling the distance of the gap to be reduced with axial movement of the turbine rotor. The arm may extend radially outward from the turbine rotor. The seal may be formed from a honeycomb shaped material.

The seal may be configured such that the gap is reduced when the turbine rotor moves axially toward the turbine stator or in another embodiment, when the turbine rotor moves away from the turbine stator. In particular, the outer sealing surface of the seal may face generally radially inward toward the arm and may include a first edge proximate to the turbine rotor and a second edge axially removed from the turbine rotor. The second edge may be positioned more radially inward than the first edge, thereby creating an angled sealing surface angled towards the turbine rotor such that as the turbine rotor is moved axially toward the turbine stator, the gap between the turbine rotor and turbine stator is reduced. In another embodiment, the outer sealing surface of the seal may face generally radially inward toward the arm and may include a first edge proximate to the turbine rotor and a second edge axially removed from the turbine rotor. The first edge may be positioned more radially inward than the second edge, thereby creating an angled sealing surface angled away from the turbine rotor such that as the turbine rotor is moved axially away from the turbine stator, the gap between the turbine rotor and turbine stator is reduced.

An advantage of this invention is that the seal reduces the gap at the gas turbine rim seal when the turbine engine is at operating conditions versus when the turbine engine is in transient operating conditions, thereby reducing leakage at an operating state and preventing contact during transient conditions.

These and other embodiments are described in more detail below.

### BRIEF DESCRIPTION OF THE DRAWINGS

The accompanying drawings, which are incorporated in and form a part of the specification, illustrate embodiments of the presently disclosed invention and, together with the description, disclose the principles of the invention.

FIG. 1 is a partial cross-sectional view of a turbine engine.

FIG. 2 is a graph of rim seal clearance from a startup state to a steady operating state.

FIG. 3 is a partial side view of a turbine stator and a turbine rotor in a nonoperating state with a seal of this invention.

FIG. 4 is a partial side view of a turbine stator and a turbine rotor in an operating state with a seal of this invention.

FIG. 5 is a partial side view of a turbine stator and a turbine rotor in a nonoperating state with an alternative seal of this invention.

FIG. 6 is a partial side view of a turbine stator and a turbine rotor in an operating state with an alternative seal of this invention.

### DETAILED DESCRIPTION OF THE INVENTION

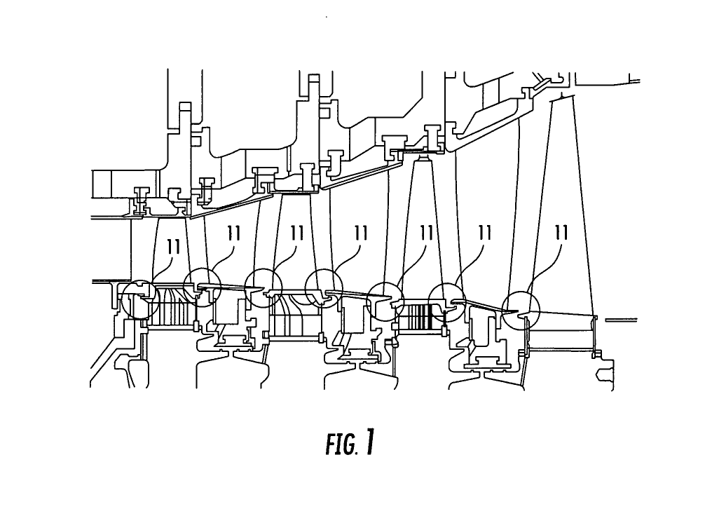

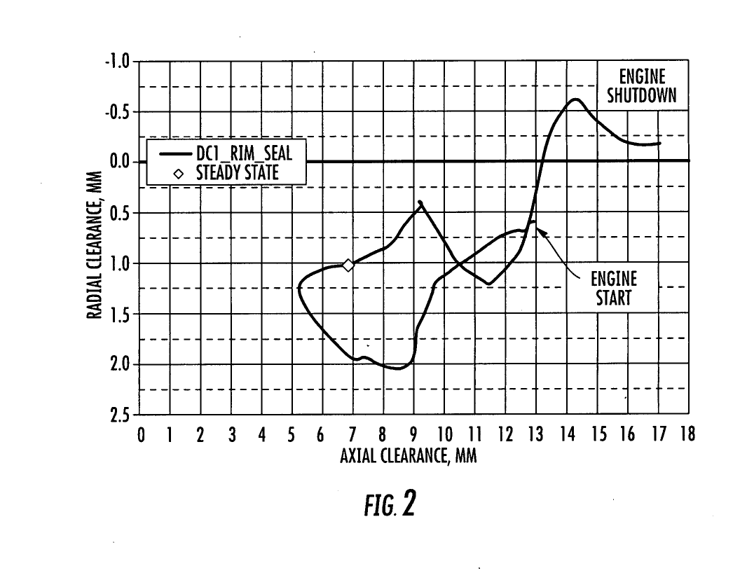

As shown in FIGS. 1-6, this invention is directed to a seal system 10 for an intersection 12 between two turbine components 14, 16 in a gas turbine engine. In at least one embodiment, the seal system 10 may be configured to seal a gap 18, as shown in FIG. 1, at a gas turbine rim seal 11 between a turbine stator 14 and a turbine rotor 16, as shown in FIGS. 3-6. The seal system 10 may be configured such that as the turbine engine heats up while moving through transient engine operation and approaching a steady state operating condition and the turbine rotor 16 undergoes axial movement, as shown in FIG. 2, the distance across the gap 18 between the turbine stator 14 and the turbine rotor 16 is reduced.

As shown in FIGS. 3-6, the seal system 10 may include a seal base 20 extending from the turbine stator 14. The seal system 10 may also include an arm 22 extending from the turbine rotor 16 and toward the seal base 20, but terminating short of the seal base 20 thereby creating a gap 18 between the seal base 20 and the arm 22. The arm 22 may extend away from the turbine rotor 16 and include at least a portion extending radially outward from the turbine rotor 16. The arm 22 may include an outer surface 26 positioned generally parallel to a longitudinal axis 24 of the turbine engine about which the turbine rotor 16 rotates. As shown in FIGS. 3-6, the arm 22 may extend generally parallel to the longitudinal axis 24 and then turn and extend generally orthogonal relative the longitudinal axis 24 and toward the turbine stator 14. The arm 22 may be formed from any appropriate material.

The seal system 10 may also include a seal 28 attached to the seal base 20 and extending radially inward from the seal base 20 toward the arm 22, wherein an outer sealing surface 30 of the seal 28 is nonparallel with a longitudinal axis 24 about which the turbine rotor 16 rotates thereby enabling the distance of the gap 18 to be reduced with axial movement of the turbine rotor 16. The seal 28 may be formed from a honeycomb shaped material. The cavities forming the honeycomb shaped material may extend generally outwardly from seal base 20 and generally orthogonal to the outer sealing surface 30 of the material.

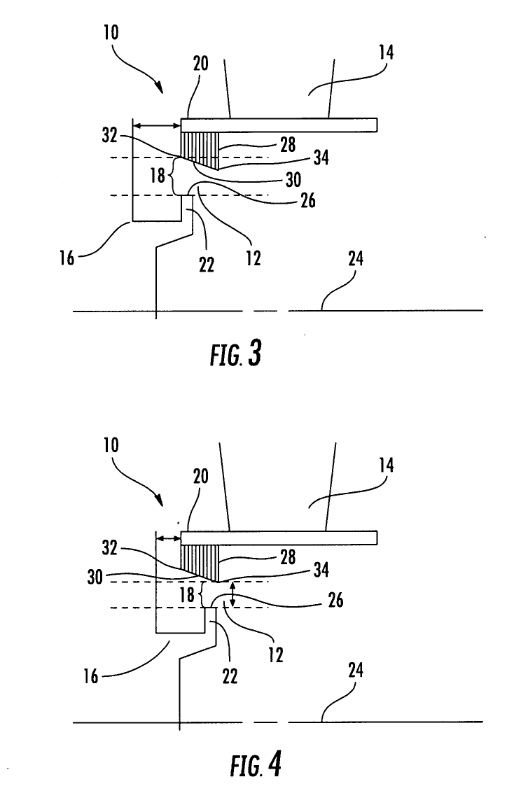

In one embodiment in which the turbine rotor 16 and turbine stator 14 grow towards each other as the turbine engine moves through start up to steady operating conditions, as shown in FIGS. 3 and 4, the outer sealing surface 30 of the seal 28 may face generally radially inward toward the arm 22. The outer sealing surface 30 may also include a first edge 32 proximate to the turbine rotor 16 and a second edge 34 axially removed from the turbine rotor 16. The second edge 34 may be positioned more radially inward than the first edge 32, thereby creating an angled sealing surface 30 angled towards the turbine rotor 16 such that as the turbine rotor 16 is moved axially toward the turbine stator 14, the gap 18 between the turbine rotor 16 and turbine stator 14 is reduced. The width of the seal 28 may be such that the first edge 32 of the seal 28 is radially outward from the arm 22 in a resting state and the second edge 34 is radially outward from the arm 22 is a steady state operating condition. The width of the seal 28, therefore, is derivative upon the amount of axial movement of the turbine rotor 16 relative to the turbine stator 14.

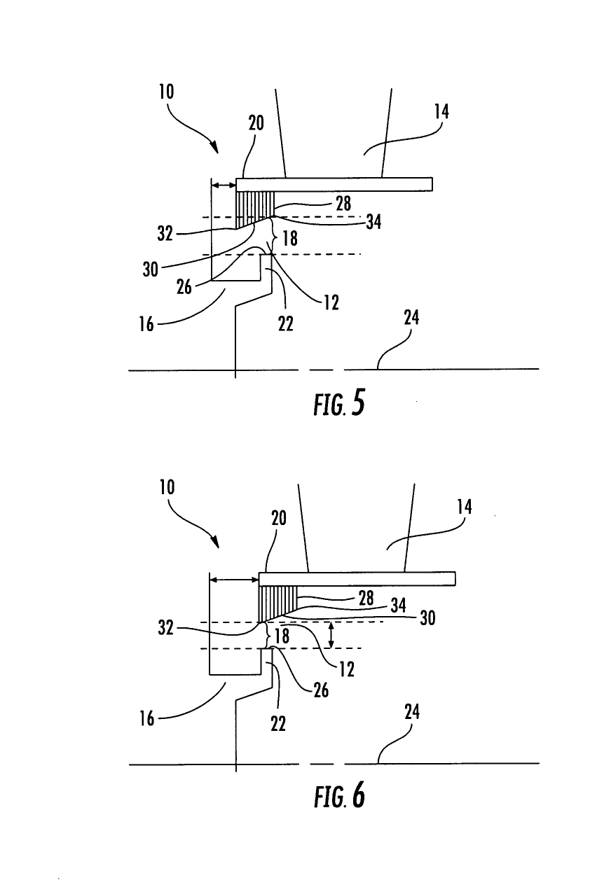

In another embodiment, as shown in FIGS. 5 and 6, the turbine rotor 16 and turbine stator 14 grow away from each other as the turbine engine moves through start up to steady operating conditions. The outer sealing surface 30 of the seal 28 may face generally radially inward toward the arm 22 and may include a first edge 32 proximate to the turbine rotor 16 and a second edge 34 axially removed from the turbine rotor 16. The first edge 32 may be positioned more radially inward than the second edge 34, thereby creating an angled sealing surface 30 angled away from the turbine rotor 16 such that as the turbine rotor 16 is moved axially away from the turbine stator 14, the gap 18 between the turbine rotor 16 and turbine stator 14 is reduced.

During use, the turbine rotor 16 moves relative to the turbine stator 14 while the turbine engine is moving through the transient state to steady state operating conditions. The outer sealing surface 30 of the seal 28 is angled such that the seal 28 reduces the gap 18, thereby increasing the sealing ability of the seal 28 during operating conditions. The seal 28 may be configured for operating conditions in which the turbine rotor 16 and turbine stator 14 move toward each other, or conditions in which the turbine rotor 16 and turbine stator 14 move away from each other.

The foregoing is provided for purposes of illustrating, explaining, and describing embodiments of this invention. Modifications and adaptations to these embodiments will be apparent to those skilled in the art and may be made without departing from the scope or spirit of this invention.

We claim:

1. A seal system for an intersection between a turbine stator and a turbine rotor, comprising:
a seal base extending from the turbine stator;
an arm extending from the turbine rotor and toward the seal base, but terminating short of the seal base thereby creating a gap between the seal base and the arm;
a seal attached to the seal base and extending radially inward from the seal base toward the arm, wherein an outer sealing surface of the seal is nonparallel with a longitudinal axis about which the turbine rotor rotates thereby enabling the distance of the gap to be reduced with axial movement of the turbine rotor.

2. The seal system of claim 1, wherein the outer sealing surface of the seal faces generally radially inward toward the arm and includes a first edge proximate to the turbine rotor and a second edge axially removed from the turbine rotor, wherein the second edge is positioned more radially inward than the first edge, thereby creating an angled sealing surface angled towards the turbine rotor such that as the turbine rotor is moved axially toward the turbine stator, the gap between the turbine rotor and turbine stator is reduced.

3. The seal system of claim 1, wherein the outer sealing surface of the seal faces generally radially inward toward the arm and includes a first edge proximate to the turbine rotor and a second edge axially removed from the turbine rotor, wherein the first edge is positioned more radially inward than the second edge, thereby creating an angled sealing surface angled away from the turbine rotor such that as the turbine rotor is moved axially away from the turbine stator, the gap between the turbine rotor and turbine stator is reduced.

4. The seal system of claim 1, wherein the arm extends radially outward from the turbine rotor.

5. The seal system of claim 1, wherein the seal is formed from a honeycomb shaped material.

6. A seal system for an intersection between a turbine stator and a turbine rotor, comprising:
a seal base extending from the turbine stator;
an arm extending radially outward from the turbine rotor and toward the seal base, but terminating short of the seal base thereby creating a gap between the seal base and the arm;
a honeycomb shaped seal attached to the seal base and extending radially inward from the seal base toward the arm, wherein an outer sealing surface of the seal is nonparallel with a longitudinal axis about which the turbine rotor rotates thereby enabling the distance of the gap to be reduced with axial movement of the turbine rotor.

7. The seal system of claim 6, wherein the outer sealing surface of the seal faces generally radially inward toward the arm and includes a first edge proximate to the turbine rotor and a second edge axially removed from the turbine rotor, wherein the second edge is positioned more radially inward than the first edge, thereby creating an angled sealing surface angled towards the turbine rotor such that as the turbine rotor is moved axially toward the turbine stator, the gap between the turbine rotor and turbine stator is reduced.

8. The seal system of claim 6, wherein the outer sealing surface of the seal faces generally radially inward toward the arm and includes a first edge proximate to the turbine rotor and a second edge axially removed from the turbine rotor, wherein the first edge is positioned more radially inward than the second edge, thereby creating an angled sealing surface angled away from the turbine rotor such that as the turbine rotor is moved axially away from the turbine stator, the gap between the turbine rotor and turbine stator is reduced.

9. A seal system for an intersection between turbine components, comprising:
a seal base extending from a first turbine component;
an arm extending radially outward from the first turbine component and toward a second turbine component, but terminating short of the seal base thereby creating a gap between the seal base and the arm;
a honeycomb shaped seal attached to the seal base and extending radially inward from the seal base toward the arm, wherein an outer sealing surface of the seal is nonparallel with a sealing surface of the arm thereby enabling the distance of the gap to be reduced with axial movement of the second turbine component.

10. The seal system of claim 9, wherein the outer sealing surface of the seal faces generally radially inward toward the arm and includes a first edge proximate to the second turbine component and a second edge axially removed from the second turbine component, wherein the second edge is positioned more radially inward than the first edge, thereby creating an angled sealing surface angled towards the second turbine component such that as the second turbine component is moved axially toward the first turbine component, the gap between the second turbine component and the first turbine component is reduced.

11. The seal system of claim 9, wherein the outer sealing surface of the seal faces generally radially inward toward the arm and includes a first edge proximate to the second turbine component and a second edge axially removed from the second turbine component, wherein the first edge is positioned more radially inward than the second edge, thereby creating an angled sealing surface angled away from the second turbine component such that as the second turbine component is moved axially away from the first turbine component, the gap between the second turbine component and the first turbine component is reduced.

12. The seal system of claim 9, wherein the first turbine component is a turbine rotor and the second turbine components is a turbine stator.
